(19) United States
(12) Patent Application Publication
(10) Pub. No.: US 2007/0117713 A1
(43) Pub. Date: May 24, 2007

(54) Tridentate metal catalyst for olefin polymerization

(76) Inventors: Abbas Razavi, Mons (BE); Vladimir Marin, Houston, TX (US); Margarito Lopez, Pasadena, TX (US)

Correspondence Address: FINA TECHNOLOGY INC, PO BOX 674412, HOUSTON, TX, 77267-4412, US

(21) Appl. No.: 11/452,692

(22) Filed: Jun. 14, 2006

Related U.S. Application Data
(63) Continuation-in-part of application No. 11/285,479, filed on Nov. 21, 2005.

(51) Int. Cl. B01J 27/24

(52) U.S. Cl. 502/200; 526/172

(57) ABSTRACT

A process for the preparation of a tridentate transition metal catalyst components incorporating pyridinyl bis-amino or monoamino ligand structures which do not require π bonding of the transition metal through the use of cyclopentadienyl rings. The ligand structure incorporates a heteroatom group that involves nitrogen in one organogroup and either oxygen or nitrogen in another organogroup. The process of preparing the catalyst component involves the reaction of a bis-amino or oxyamino pyridenyl ligand compound with an organo transition metal compound involving a tetrabenzyl ligand or other functional group ligands linked to a transition metal such as titanium zirconium or hafnium.

This application is a continuation in part of application Ser. No. 11/285,479, filed Nov. 21, 2005.

### FIELD OF THE INVENTION

This invention relates to olefin polymerization catalysts incorporating tridentate pyridinyl transition metal catalyst components, and more particularly to the preparation of catalyst components incorporating tridentate bis- and mono-imino pyridinyl ligand structures.

### BACKGROUND OF THE INVENTION

Polymers of ethylenically unsaturated monomers such as polyethylene or polypropylene homopolymers and ethylene-propylene copolymers may be produced under various polymerization conditions and employing various polymerization catalysts. Such polymerization catalysts include Ziegler-Natta catalysts and non-Ziegler-Natta catalysts, such as metallocenes and other transition metal catalysts which are typically employed in conjunction with one or more co-catalysts. The polymerization catalysts may be supported or unsupported.

Homopolymers or copolymers of alpha olefins may be produced under various conditions in polymerization reactors which may be batch type reactors or continuous reactors. Continuous polymerization reactors typically take the form of loop-type reactors in which the monomer stream is continuously introduced and a polymer product is continuously withdrawn. For example, the production of polymers such as polyethylene, polypropylene or ethylene-propylene copolymers involve the introduction of the monomer stream into the continuous loop-type reactor along with an appropriate catalyst system to produce the desired homopolymer or copolymer. The resulting polymer is withdrawn from the loop-type reactor in the form of a “fluff” which is then processed to produce the polymer as a raw material in particulate form as pellets or granules. It is often the practice in the production of ethylene homopolymers and ethylene C₃₊ alpha olefin copolymers to employ substantial amounts of molecular weight regulators such as hydrogen to arrive at polymers or copolymers of the desired molecular weight. Typically in the polymerization of ethylene, hydrogen may be employed as a regulator with the hydrogen being introduced into the monomer feed stream in amounts of about 10 mole % and higher of the ethylene feed stream. In the case of C₃₊ alpha olefins, such a propylene or substituted ethylenically unsaturated monomers such as styrene or vinyl chloride, the resulting polymer product may be characterized in terms of stereoregularity, such as in the case of, for example, isotactic polypropylene or syndiotactic polypropylene. Other unsaturated hydrocarbons which can be polymerized or copolymerized with relatively short chain alphaolefins, such as ethylene and propylene include dienes, such as 1,3-butadiene or 1,4-hexadiene or acetylenically unsaturated compounds, such as methylacetylene. Tridentate components incorporating bis-imino or oxo-imine ligand structures may be employed in the polymerization of olefins to produce ethylene or propylene homopolymers or copolymers.

### SUMMARY OF THE INVENTION

In accordance with the present invention, there is provided a process for the preparation of tridentate transition metal catalyst components incorporating bis-imino or mono-imino pyridinyl ligand structures. In carrying out the invention there is provided an organo transition metal compound which is reactive with an amino pyridinyl ligand structure. The organo transition metal compound is characterized by the formula:
MRₙ (1)
In Formula (1):
each R is independently a C₁-C₂₀ alkyl group, a C₆-C₃₀ aryl group, a C₇-C₃₀ alkyl aryl group, a C₁-C₂₀ alkoxy group, a C₇-C₃₀ aryloxy, or a C₁-C₂₀ amido-group.
n is from 3 to 5 and
M is a transition metal from group 4 or group 5 of the Periodic Table of Elements (new notation).

The transition metal compound is reacted with an imino-pyridinyl ligand compound characterized by the formula: 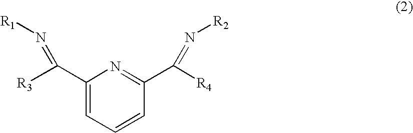
wherein: R₁ and R₂, R₃, R₄ are each independently a Cl-C₃₀ aliphatic group; or a C₆-C₃₀ aryl group, C₁-C₂₀ alkoxy group, a C₇-C₃₀ aryloxy group, a C₁-C₂₀ amido-group, or a C₄-C₃₀ alicyclic group, and.
n is from 3 to 5

or by the formula: 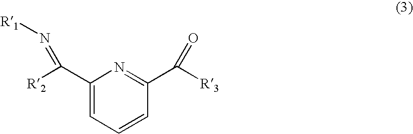
wherein: R′₁, R′₂ or R′₃ are each independently a C₁-C₃₀ hydrocarbyl group

Where the imino-pyridinyl ligand compound is characterized by formula (2), the resulting reaction product is a catalyst component characterized by formula (4) 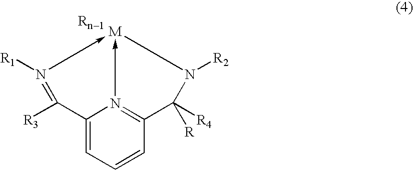
wherein: M, R, R₁, R₂, R₃ and R₄ and n are as defined previously.

In formula (4), the tridentate ligand is bonded to the metal M by one sigma bond and two dative bonds.

Where the imino-pyridinyl ligand compound is a mono-imino compound characterized by formula (3), the resulting catalyst component is characterized by the formula:

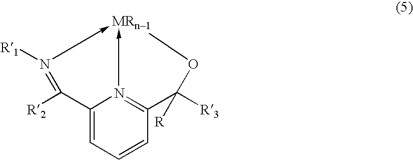

In formula (5), the tridentate ligand is bonded to the metal M by one sigma bond from oxygen and two dative bonds and M, R, R′₁, R′₂, R′₃ are as defined previously.

In embodiments of the invention R is a mononuclear aryl group, more particularly a benzyl group, or a C₁-C₄ alkyl group. In further embodiments of the invention the substituents R₃, R₄, R′₂, and R′₃ are methyl groups and the substituents R₂, R₃ and R′₁ are monoaromatic or polyaromatic groups. In another aspect of the invention R is a benzyl group and M is selected from the group consisting of titantium, zirconium and hafnium.

In another embodiment of the invention, there is provided a phenyl transition metal compound reactive with an imino-pyridinyl ligand structure. The phenyl transition metal compound is characterized by the formula:
M(R_{f}Ph)₄ (6)

In formula (6),

Ph is a phenyl group

M is a Group IV or a Group V transition metal; and

R_{f} is a functional substituent on the phenyl group linking the phenyl group to the transition metal M.

The aforementioned compound is reacted with an imino-pyridinyl transition metal compound which may be characterized by formula:

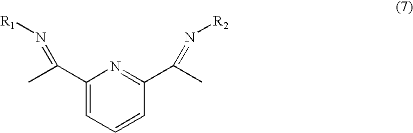

In formula (7), R₁ and R₂ are each independently a C₁-C₁₄ hydrocarbyl group or by the formula

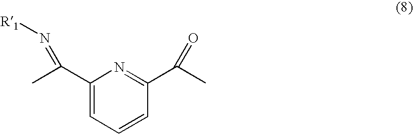

In formula (8), R′₁ is a C₁-C₂₀ hydrocarbyl group.

Where the imino-pyridinyl ligand compound is characterized by formula (7), the resulting reaction product is a catalyst component characterized by formula (9):

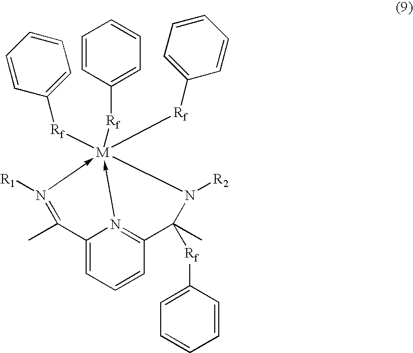

Where the imino-pyridinyl ligand compound is mono-imino compound characterized by formula (8), the resulting catalyst component is characterized by the following formula:

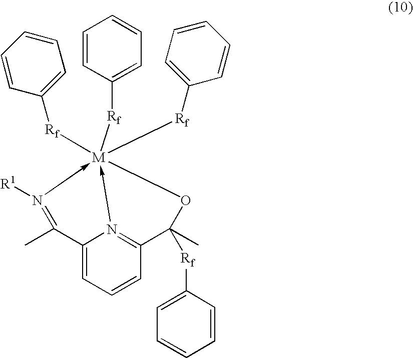

In one embodiment of the invention R_{f} is an alkyl group, an aryl group, an imido group, an imino group, and ether group, an alkyl group, or an aryl group. In another embodiment of the invention, R_{f} is a mononuclear aryl group. In yet another embodiment, R_{f} is a C₁-C₃ alkyl group. Where R_{f} is a methyl group, i.e., the compound of formula (1) is a tetra substituted benzyl transition metal compound, the catalyst component is characterized by formula: 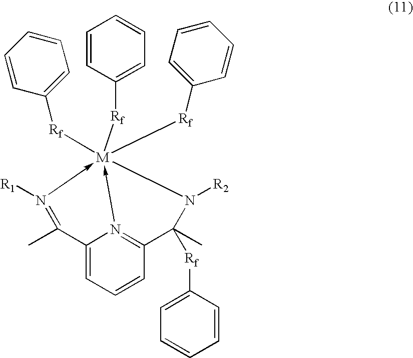
or by the formula:

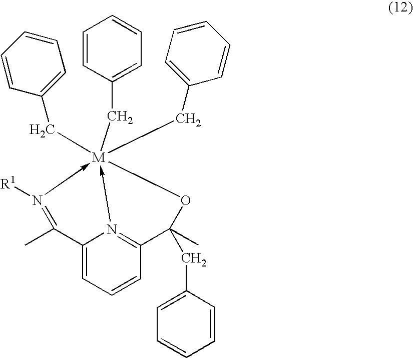

In a further embodiment of the invention R₁ and R₂ of formulas 11 and 12 are each independently an aryl group that is substituted or unsubstituted and more specifically a mononuclear aryl group that is substituted or unsubstituted.

In one embodiment of the invention, the aryl groups R₂ and R₃ are the same and are polynuclear aryl groups and specifically indenyl groups which are substituted or unsubstituted or fluorenyl groups which are substituted or unsubstituted.

Generally M takes the form of a group 4 transition metal, specifically, titanium, zirconium or hafnium.

### DETAILED DESCRIPTION OF THE INVENTION

The present invention involves the preparation of a bridged transition metal catalyst components incorporating pyridinyl bis-amino or monoamino ligand structures. The catalyst components prepared in accordance with the present invention can be described as non-metallocene catalyst compounds in that they do not require π bonding of the transition metal through the use of cyclopentadienyl rings. As described in greater detail below, the tridentate ligand structures incorporate a heteroatom group that involve nitrogen in one organogroup and either oxygen or nitrogen in another organogroup.

The process of preparing the catalyst component in accordance with the present invention involves an efficient and a direct reaction which employs relatively inexpensive starting materials which do not involve exotic chemical compounds and which react to provide high yields of the catalyst component. The process can be carried out in large scale production operations which do not dictate the use of time consuming and complicated purification procedures. The process involves the reaction of a bis-amino or oxyamino pyridenyl ligand compound with a transitition metal compound involving a tetrabenzyl ligand or other functionally group ligands as described above. The bis-amino or amino oxy compound is reacted with at least one equivalent and more specifically about 1.2 equivalents of the transition metal compound. The reaction may be carried out in the presence of a polar or non-polar solvent such as benzene, toluene or methylene chloride. The reaction between the transition metal compound and the amino-pyridenyl compound typically will be carried out at a temperature ranging from about 20-50° C. for a time period of about 1-96 hours and more specifically 2-24 hours. The resulting catalyst component can be readily isolated by crystallization.

As described below, the pyridinyl ligand compound reacted with the phenyl transition metal compound is a pyridinyl amine-imine ligands as characterized by the formula: 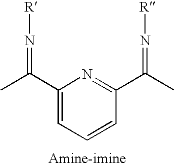
Amine-imine or oxo-imine ligands as characterized by the formula: 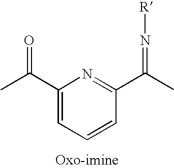
Specific embodiments of these imino ligand structures are exemplified by the catalyst components identified below as catalyst components C1-C11.

The catalyst components prepared in accordance with the present invention may be employed in the polymerization of an ethylenically unsaturated monomer, such as ethylene or propylene, or in the copolymerization of such monomers with a second monomer. Thus, the catalyst component may be employed in the polymerization of ethylene or propylene to produce polyethylene homopolymer, polypropylene homopolymer or copolymers of ethylene or propylene. Suitable monomer systems include ethylene and a C₃₊ alpha olefin having from 3 to 20 carbon atoms. For example, copolymers of ethylene and a higher molecular weight alpha olefin comonomer such as 1-hexene may be produced. Propylene polymers which are atactic or have moderate isotacticity or syndiotacticity may be produced as indicated by the expermintal work presented below.

The catalyst components prepared in accordance with the present invention can be employed in catalyst systems incorporating an activating co-catalyst. Suitable activating co-catalysts may take the form of co-catalysts such are commonly employed in metallocene-catalyzed polymerization reactions. Thus, the activating co-catalyst may take the form of an alumoxane co-catalyst. Alumoxane co-catalysts are also referred to as aluminoxane or polyhydrocarbyl aluminum oxides. Such compounds include oligomeric or polymeric compounds having repeating units of the formula: 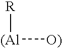
where R is an alkyl group generally having 1 to 5 carbon atoms. Alumoxanes are well known in the art and are generally prepared by reacting an organo-aluminum compound with water, although other synthetic routes are known to those skilled in the art. Alumoxanes may be either linear polymers or they may be cyclic, as disclosed for example in U.S. Pat. No. 4,404,344. Thus, alumoxane is an oligomeric or polymeric aluminum oxy compound containing chains of alternating aluminum and oxygen atoms whereby the aluminum carries a substituent, preferably an alkyl group. The structure of linear and cyclic alumoxanes is generally believed to be represented by the general formula —(Al(R)—O—)-m for a cyclic alumoxane, and R₂Al—O—(Al(R)—O)m-AlR₂ for a linear compound wherein R independently each occurrence is a C₁-C₁₀ hydrocarbyl, preferably alkyl or halide and m is an integer ranging from 1 to about 50, preferably at least about 4. Alumoxanes also exist in the configuration of cage or cluster compounds. Alumoxanes are typically the reaction products of water and an aluminum alkyl, which in addition to an alkyl group may contain halide or alkoxide groups. Reacting several different aluminum alkyl compounds, such as, for example, trimethylaluminum and tri-isobutylaluminum, with water yields so-called modified or mixed alumoxanes. Suitable alumoxanes are methylalumoxane and methylalumoxane modified with minor amounts of other higher alkyl groups such as isobutyl. Alumoxanes generally contain minor to substantial amounts of the starting aluminum alkyl compounds. A specific co-catalyst, prepared either from trimethylaluminum or tri-isobutylaluminum, is sometimes referred to as poly (methylaluminum oxide) and poly (isobutylaluminum oxide), respectively.

The alkyl alumoxane co-catalyst and transition metal catalyst component can be employed in any suitable amounts to provide an olefin polymerization catalyst. Suitable aluminum transition metal mole ratios are within the range of 10:1 to 20,000:1 and more specifically within the range of 100:1 to 2,000:1. Normally, the transition metal catalyst component and the alumoxane, or other activating co-catalyst as described below, are mixed prior to introduction in the polymerization reactor in a mode of operation such as described in U.S. Pat. No. 4,767,735 to Ewen et al. The polymerization process may be carried out in either a batch-type, continuous or semi-continuous procedure, but normally polymerization of the ethylene will be carried out in a loop-type reactor of the type disclosed in the aforementioned U.S. Pat. No. 4,767,735. Typical loop-type reactors include single loop reactors or so-called double loop reactors in which the polymerization procedure is carried in two series connected loop reactors. As described in the Ewen et al. patent, when the catalyst components are formulated together, they may be supplied to a linear tubular pre-polymerization reactor where they are contacted for a relatively short time with the pre-polymerization monomer (or monomers) prior to being introduced into the main loop type reactors. Suitable contact times for mixtures of the various catalyst components prior to introduction into the main reactor may be within the range of a few seconds to 2 days. For a further description of suitable continuous polymerization processes which may be employed with catalyst components prepared in accordance with the present invention, reference is made to the aforementioned U.S. Pat. No. 4,767,735, the entire disclosure of which is incorporated herein by reference.

Other suitable activating co-catalysts which can be used with the afore-mentioned catalyst component include those cocatalysts which function to form a catalyst cation with an anion comprising one or more boron atoms. By way of example, the activating co-catalyst may take the form of triphenylcarbenium tetrakis(pentafluorophenyl) boronate as disclosed in U.S. Pat. No. 5,155,080 to Elder et al. As described there, the activating co-catalyst produces an anion which functions as a stabilizing anion in a transition metal catalyst system. Suitable noncoordinating anions include [W(PhF₅)]⁻, [Mo(PhF₅)]⁻ (wherein PhF₅ is pentafluorophenyl), [ClO₄]⁻, [S₂O₆]⁻, [PF₆]⁻, [SbR₆]⁻, [AlR₄]⁻ (wherein each R is independently Cl, a C₁-C₅ alkyl fluorinated aryl group). Following the procedure described in the Elder et al. patent, triphenylcarbenium tetrakis(pentafluorophenyl) boronate may be reacted with the afore-mentioned pyridinyl-linked amino catalyst component in a solvent, such as toluene, to produce a coordinating cationic-anionic complex. For a further description of such activating co-catalyst, reference is made to the aforementioned U.S. Pat. No. 5,155,080, the entire disclosure of which is incorporated herein by reference.

In addition to the use of an activating co-catalyst, the polymerization reaction may be carried out in the presence of a scavenging agent or polymerization co-catalyst which is added to the polymerization reactor along with the catalyst component and activating co-catalyst. These scavengers can be generally characterized as organometallic compounds of metals of Groups 1, 2, and 13 of the Periodic Table of Elements (new notation). As a practical matter, organoaluminum compounds are normally used as co-catalysts in polymerization reactions. Specific examples include triethylaluminum, tri-isobutylaluminum, diethylaluminum chloride, diethylaluminum hydride and the like. Specific scavenging co-catalysts include methylalumoxane (MAO), triethylaluminum (TEAL) and tri-isobutylaluminum (TIBAL).

The catalyst components prepared in accordance with the present invention may be employed in homogeneous polymerization systems or in heterogeneous systems in which the catalyst components may be supported on suitable supports, such as silica. In addition, hydrogen may be introduced into the polymerization reaction zone as a molecular weight regulator.

In experimental work respecting the present invention, Group 4 metal catalysts in which the Group 4 metal was titanium, zirconium or hafnium were prepared by reacting tetrabenzyl Group 4 metal complexes (M(CH₂Ph)₄) with tridentate bis-(N,N,N) and mono-(O,N,N) imino-pyridine ligands to arrive at the metal component. The tridentate ligand structures were synthesized by the condensation reaction of 2,6-diacetyl pyridine with two equivalents of the corresponding amines for the bis-imine ligands as characterized by the formula: 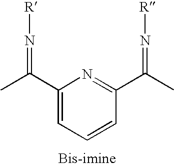
Bis-imine
or with one equivalent of the corresponding amines for the oxy mono-imine ligand structure characterized by the following formula: 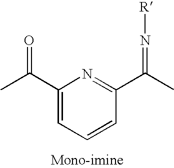
Mono-imine

The reaction routes are illustrated schematically by the following diagram to produce ligands identified as ligands L1, L2, L3 and L4 for the bis-imines and ligands L5 and L6 for the mono-imines:

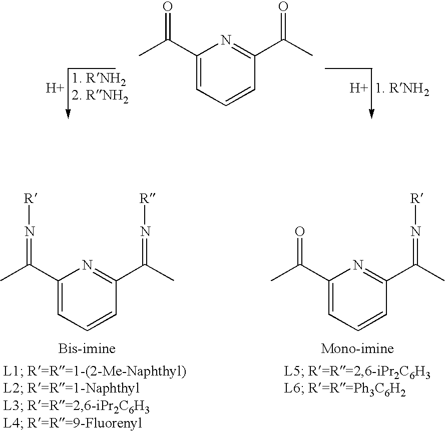

Bis-imine ligands identified below as L7, L8 and L9 in which the C═N double bond is displaced one carbon atom outward from the double bonds shown in ligands L1-L4 were prepared by the condensation reaction of 2,6-(1,1′-diethylamino)-pyridine with two equivalents of the corresponding cyclic ketone as indicated by the following reaction route:

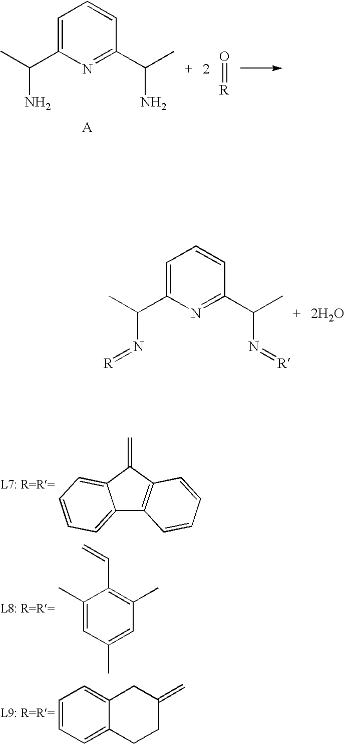

The tetrabenzyl Group 4 metal complexes were synthesized by the reaction of four equivalents of the Grignard reagent, benzylmagnesium chloride, with the Group IV tetrachloride metals in diethyl ether at a temperature of about −20 ° C. or −78° C. in an atmosphere shielded from light by the following reaction route:

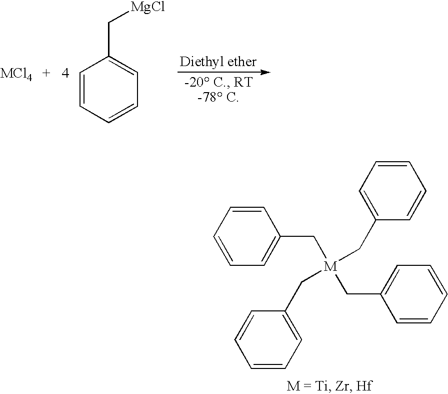

The following procedure for the preparation of Zirconium tetrabenzyl is illustrative.

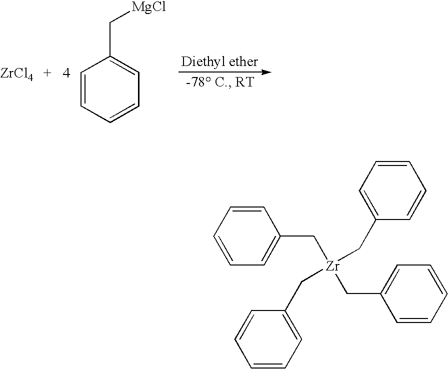

The reaction was performed under an inert atmosphere and was kept out of the light throughout all the manipulations.

In a 250 ml round, bottom flask that was equipped with a magnetic stirrer, was added the ZrCl₄ (3.0 grams, 1.28E02 moles). The flask was then equipped with a pressure equalized dropping funnel and capped with a rubber septum. The flask was then cooled to 78° C. and the ZrCl₄ was slurried in 25 ml of diethyl ether. The reaction was then left to warm up to room temperature over the weekend. The reaction flask was then cooled to −78° C. and the Benzylmagnesium Chloride was added dropwise over 35 minutes. The reaction mixture turned from a white slurry to a yellow slurry. The mixture was then left to slowly warm up to room temperature overnight. The solids were then left to settle and the solution was then transferred into another 250 ml round bottom flask that was equipped with a magnetic stirrer and capped with a rubber septum. After removal of the solvent by vacuum, a dark orange/yellow solid was obtained. This solid was then re-dissolved in 40 ml of toluene and filtered with a filter cannula into another 250 ml round bottom flask that was equipped with a magnetic stirrer and capped with a rubber septum. The remaining solids were washed 3 times with 10 ml of toluene. The toluene was then concentrated to about 20 ml and left to stand overnight at room temperature and again concentrated to about 15 ml. Some crystalline orange/yellow solids begin to form. The saturated toluene solution was then transferred into 50 ml Wheaton vial (as the solution was being transferred lots of crystalline orange/yellow solids begin to form). The vial was then capped with a Teflon-lined cap and left in the glove box freezer. After 5 days, orange yellow crystals were formed. The saturated toluene solution was poured into a 250 ml round bottom schlenk-type flask. After washing the solids 4 times each with 10 ml of hexane, they were transferred into a 100 ml schlenk-type round bottom flask and dried under vacuum for 4 hours at room temperature. The solids were stored in the glove box freezer for further use. ¹H-NMR (300 MHz, benzene-d6) δ: 6.96 (m, 12H, Ph), 6.33 (d, 8H,Ph), 1.50 (s, 8H, CH2).

The synthesis of the Group 4 metal complexes was achieved by the reaction of one equivalent of the tetrabenzyl metal complex, M(CH₂Ph)₄, in which M was titanium, zirconium or hafnium, in benzene with one equivalent of the bis-imine or mono-imine ligands at ambient temperature conditions. The reaction mixture was stirred for at least 16 hours and aliquots of the product were employed for nuclear magnetic resonance characterizations to identify the catalyst components. The foregoing reaction schemes and the corresponding metal complexes identified herein as catalyst components C1-C11 are illustrated schematically as follows:

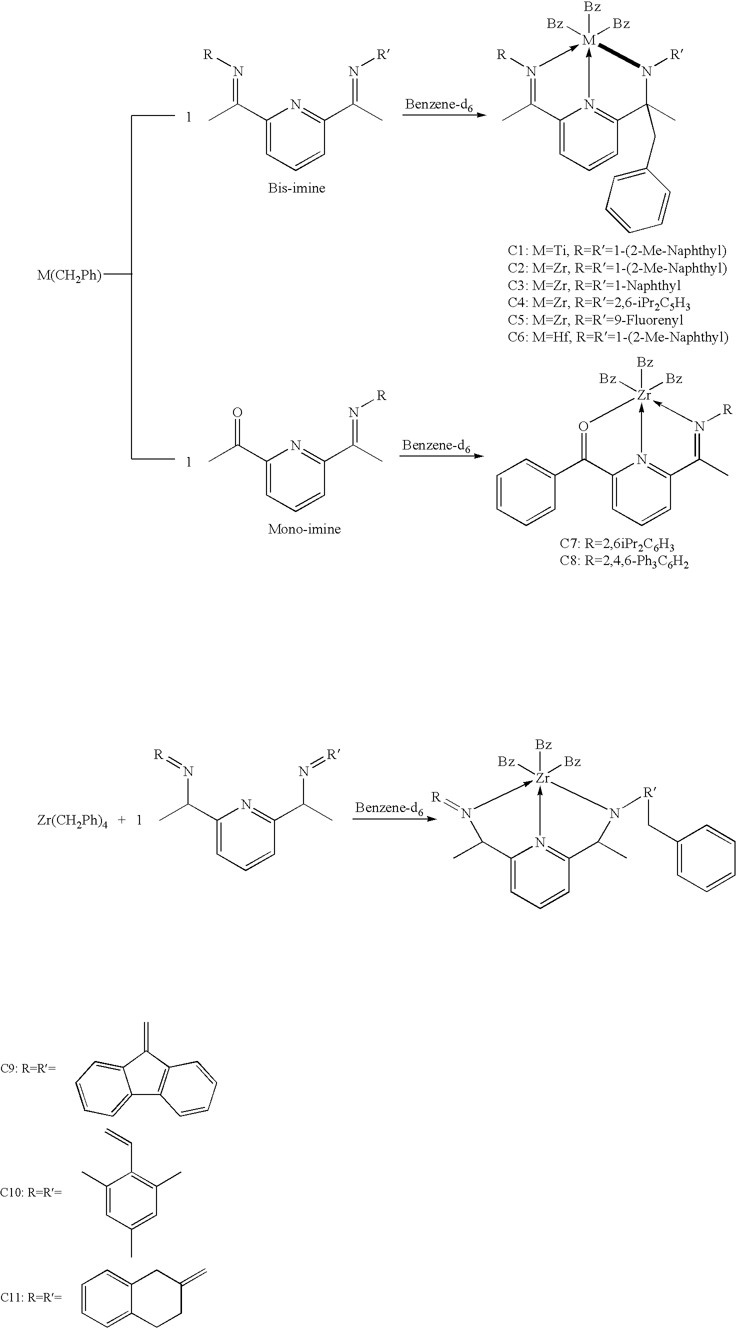

Structural formulas for the catalyst components C1-C11 are indicated below. In the following structural formulas, a methyl group is indicated by /, an isopropyl group by 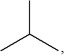
and a tertiary butyl group by 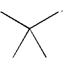 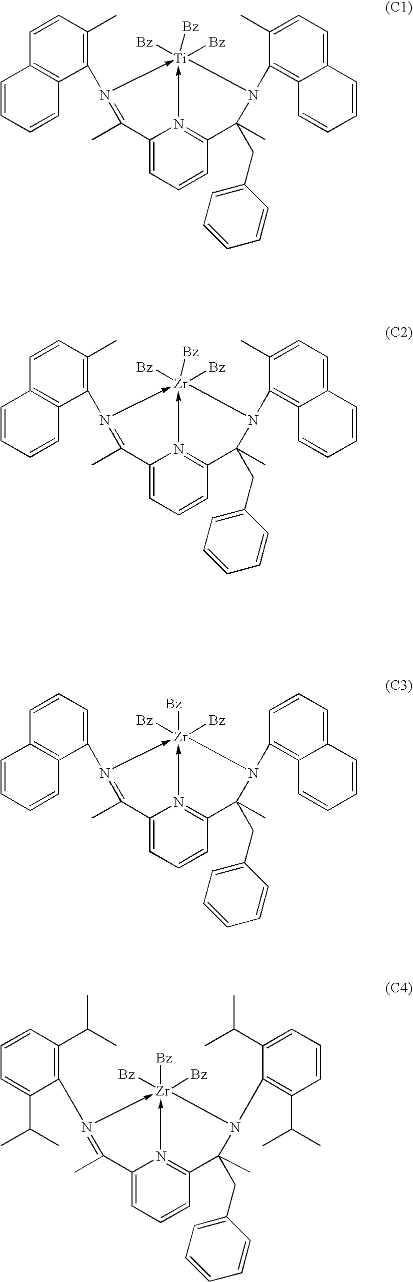 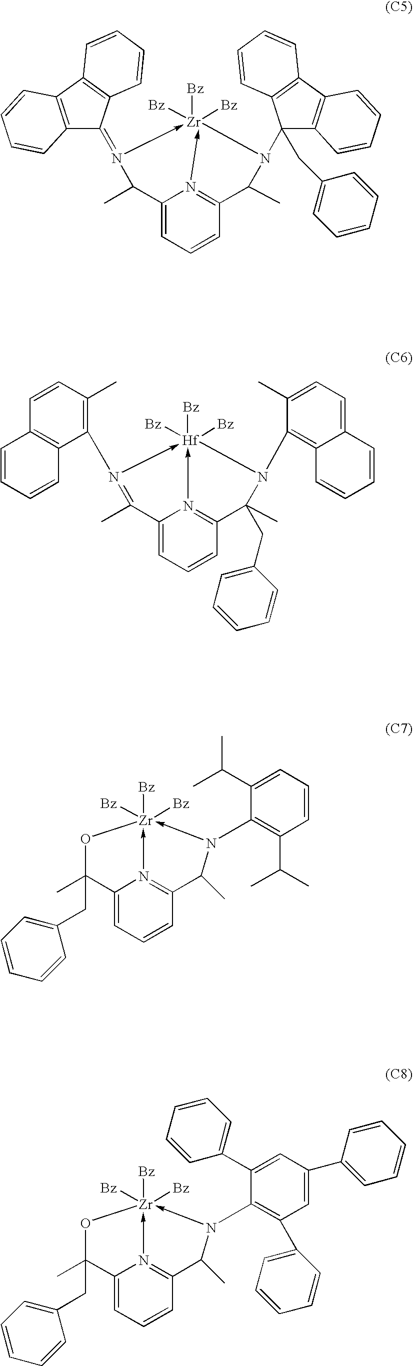 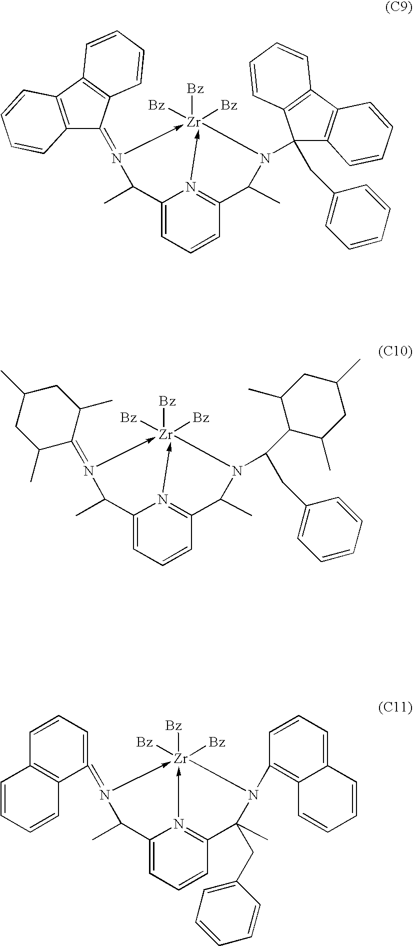
As indicated by the above structural formulas, catalysts C9, C10 and C11 are characterized by tridentate ligand structures containing one fixed imino group and one imino group that has free rotational characteristics. Specific synthesis procedures and NMR characteristics of the catalysts C1-C11 are set forth below.

Catalyst 1: To a stirred solution of the bis-imine L1 (101.6 mg, 230 μmol) in toluene (3 mL), was slowly added a solution of Ti(CH₂Ph)₄ (100 mg., 242 μmol) in toluene (3 mL) at −10 ° C. over 3 minutes. Immediately, the reaction turned to a reddish brown solution. After stirring at room temperature (20° C.) for 3 days in the absence of light, the product was obtained as a dark green solution. An aliquot of the reaction mixture was used for testing in ethylene polymerization at one-atmosphere.

Catalyst 2: In a 20 ml reaction tube that was equipped with a magnetic stirrer was added the bis-imine (0.20 g., 4.52E-4E-4 moles) and the Zr(CH₂Ph)₄ (0.10 g., 2.19E-4 moles) dissolved in 3 ml of benzene-d6. Immediately, the solution turned to a dark brown solution. The vial was capped and covered with aluminum foil and left to stir at room temperature (20° C.) overnight. ¹H-NMR (300 MHz, benzene-d6) δ 3.56 (d, J=12.9 Hz, ABX, PhCH₂CH₃), 3.30 (d, J=12.3 Hz, ABX, PhCH₂CH₃), 2.72 (d, J=12.0 Hz, Abq, Zr(CH₂Ph)), 2.60 (d, J=11.1 Hz, Abq, Zr(CH₂Ph)).

Catalysts 3-11 were synthesized in a similar fashion as catalyst 1 unless otherwise indicated below.

Catalyst 3: In a 20 ml vial that was equipped with a magnetic stirrer was added the bisimine (0.18 g., 0.438 mmoles) and the Zr(Bz)4 (0.20 g., 0.438 mmoles) and dissolved in 2 ml of benzene-d6. Immediately, the solution turned to a dark red/brown solution. The vial was capped and covered with aluminum foil and left to stir at room temperature (20° C.) overnight. ¹H-NMR (300 MHz, benzene-d6, 35° C.) ABX signal at δ 3.44 (J=12.9 Hz, PhCH₂CH₃) and δ 3.02 (J=12.6 Hz, PhCH₂CH₃). ¹H-NMR (300 MHz, benzene-d6) δ 3.44 (d, J=12.9 Hz, ABX, PhCH₂CH₃), 3.02 (d, J=12.6 Hz, ABX, PhCH₂CH₃), 2.85 (d, J=13.2 Hz ABq Zr(CH₂Ph)), 2.60 (d, J=13.5 Hz, ABq Zr(CH₂Ph)).

Catalyst 4: In a 20 ml vial that was equipped with a magnetic stirrer, was added the bisimine (0.21 g., 0.435 mmoles) and the Zr(Bz)4 (0.20 g., 0.438 mmoles) and slurried in 5 ml of benzene-d6. There was no immediate reaction observed. The vial was capped and covered with aluminum foil and left to stir at room temperature (20° C.) for 2 days. ¹H-NMR (300 MHz, benzene-d6, 35° C.) ABX signal at δ 3.88 (J=12.9 Hz, PhCH₂CH₃) and δ 3.25 (J=12.9 Hz PhCH₂CH₃). ¹H-NMR (300 MHz, benzene-d6) δ 4.12 (d, J=12.9 Hz, ABX, PhCH₂CH₃), 3.87 (d, J=13.2 Hz, ABX, PhCH₂CH₃), 3.28 (d, J=12.6 Hz, ABq Zr(CH₂Ph )), 3.11 (d, J=11.1 Hz, Abq, Zr(CH₂Ph)).

Catalyst 5: In a 20 ml vial equipped with a magnetic stirrer was added the bis-imine L4 (0.22 mg., 0.449 μmoles) and the Zr(CH₂Ph)₄ (20.5 mg., 0.449 μmoles) dissolved in 1 ml of benzene-d6. Immediately, the solution turned to a dark red/brown solution. The vial was capped and covered with aluminum foil and left to stir at room temperature (20° C.) overnight. Analysis of this complex was not performed. The catalyst structure is proposed due to the similarities of the reaction of Zr(CH₂Ph)₄ with similar bis-imines. An aliquot of the reaction mixture was used for testing in ethylene polymerization at one-atmosphere.

Catalyst 6: ¹H-NMR (300 MHz, benzene-d6) δ 3.56 (d, J=12.6 Hz, ABX, PhCH₂CH₃), 3.36 (d, J=12.3 Hz, ABX, PhCH₂CH₃), 2.76 (d, J=11.4 Hz, Abq, Zr(CH₂Ph)), 2.65 (d, J=9.60 Hz, Abq, Zr(CH₂Ph)).

Catalyst 7: ¹H-NMR (300 MHz, benzene-d6) δ 3.62 (d, J=12.9 Hz, ABX, PhCH₂CH₃), 3.04 (d, J=12.9 Hz, ABX, PhCH₂CH₃), 2.57 (d, J=12.0 Hz Abq, Zr(CH₂Ph)), 2.23 (d, J=10.8 Hz, Abq, Zr(CH₂Ph)).

Catalyst 8: In a 20 ml reaction tube equipped with a magnetic stirrer was added the bis-imine (40.9 mg., 87.6 μmoles) and the Zr(CH₂Ph)₄ (40.5 mg., 88.8 μmoles) dissolved in 2 ml of ml of benzene-d6. Immediately, the solution turned to a dark red/brown slurry. The vial was capped and covered with aluminum foil and left to stir at room temperature (20° C.) overnight. The product was obtained as a dark red/brown solution. Analysis of this complex was not performed. The catalyst structure is proposed due to the similarities of the reaction of Zr(CH₂Ph)₄ with bis-imine L5. An aliquot of the reaction mixture was used for testing in ethylene polymerization at one-atmosphere.

Catalyst 9: In a 20 ml vial equipped with a magnetic stirrer was added the bis-imine L6 (59 mg., 0.120 mmoles) and the Zr(CH₂Ph)₄ (53 mg., 0.116 mmoles) dissolved in 2 ml of toluene. Immediately, the solution turned to a dark brown solution. The vial was capped and covered with aluminum foil and left to stir at room temperature (20° C.) overnight. Analysis of this complex was not performed. The catalyst structure is proposed due to the similarities of the reaction of Zr(CH₂Ph)₄ with bis-imine L5. An aliquot of the reaction mixture was used for testing in ethylene polymerization at one-atmosphere.

Catalyst 10: In a 20 ml vial equipped with a magnetic stirrer was added the bis-imine L7 (44.5 mg., 0.104 mmoles) and the Zr(CH₂Ph)₄ (47.3 mg., 0.104 mmoles) and dissolved in 3 ml of benzene-d6. Immediately, the solution turned to a clear, green brown solution. The vial was capped and covered with aluminum foil and left to stir at room temperature (20° C.) overnight. Analysis of this complex was not performed. The catalyst structure is proposed due to the similarities of the reactions of Zr(CH₂Ph)₄ with similar bis-imines. An aliquot of the reaction mixture was used for testing in ethylene polymerization at one-atmosphere.

Catalyst 11: In a 20 ml vial equipped with a magnetic stirrer was added the bis-imine L8 (18.7 mg., 44.3 μmoles) and the Zr(CH₂Ph)₄ (20.2 mg., 44.3 μmoles) and dissolved in 3 ml of benzene-d6. Immediately, the solution turned to a yellow orange solution. The vial was capped and covered with aluminum foil and left to stir at room temperature (20° C.) overnight. Analysis of this complex was not performed. The catalyst structure is proposed due to the similarities of the reactions of Zr(CH₂Ph)₄ with similar bis-imines. An aliquot of the reaction mixture was used for testing in ethylene polymerization at one atmosphere.

The various catalyst components identified above as C1-C11 were tested in polymerization runs carried out in stirred laboratory reactors available from Autoclave Engineers under the designation Zipperclave. Two reactors were employed and were operated under conditions identified below as condition B1 and condition B2. The catalyst components were tested by using an aliquot of the crude reaction product which was activated with methylalumoxane (MAO) and used in the polymerization of ethylene at one atmosphere in a toluene slurry. Since the new catalysts were tested without isolation and purification from the reaction mixtures, in general, only trace amounts of polymer were observed. It is expected that higher activities would be achieved after isolation and purification of the catalyst. However, the polymerization work as described below was useful in establishing relative activities of the various catalyst components.

A preliminary screening evaluation for the new catalysts was performed in the polymerization of ethylene at one atmosphere in a toluene solution at 25° C. Upon activation with MAO, each catalyst produced a clear, reddish brown solution as the active species. Table 1 summarizes the polymerization conditions and results. Most of the complexes were active in the polymerization of ethylene. Catalysts C2, C3 and C4 produced exothermic reactions during the polymerization. Catalyst C2 showed the highest activity producing a ΔT of 41° C. Catalyst C10 was tested by using MAO and MMAO-3A as activators, but in both cases the catalyst only produced trace amounts of polymer that was difficult to isolate.

TABLE 1
One-atmosphere Ethylene Polymerizations at 25° C.^{(a)}

| | Catalyst | | Time | | | Activity | | |
|---|---|---|---|---|---|---|---|---|
| Catalyst # | (mg) | Activator | (min.) | Yield | | (gPE/gcat/h) | Mw | Mw/Mn |
| C1 | 5.0 | MAO | 30 | 0.265 | g | 106 | | |
| C2 | 20.0 | MAO | 30 | 6.68 | g | 668 | 156,000 | 31.2 |
| C3 | 190.0 | MAO | 30 | 4.90 | g | 52 | 14,000 | 7.71 |
| C4 | 82.0 | MAO | 15 | 0.40 | g | 19 | 89,000 | 11 |
| C6 | 10.0 | MAO | 60 | Trace | | | | |
| C7 | 11.3 | MAO | 90 | 0.140 | g | 8 | 832,000 | 67 |
| C8 | 8.1 | MAO | 120 | 85 | mg | 5 | 838,000 | 66.9 |
| C9 | 56.0 | MAO | 120 | 0.340 | g | 3 | | |

| | | | | |
|---|---|---|---|---|
| C10 | 10.0 | MAO | 60 | Trace |
| C10 | 5.0 | MMAO-3A^{(b)} | 60 | Trace |

^{(a)}For each polymerization, 50 ml of toluene and 2.0 ml (95.2 mmol) of MAO (30 wt. % in toluene, Albemarle) were used.
^{(b)}MMAO-3A (AKZO 7 wt. % in Heptane, contains about 30% of isobutyl groups).

In general, the catalyst activity trend under one atmosphere of ethylene was established as follows:
C2>>C1>C3>C4>C7>C8>C9>C6 and C10
   All the catalysts produced PE with low molecular weights.

Ethylene polymerizations were conducted in the Zipperclave bench reactors under conditions identified as B1 and B2. For each catalyst, MAO was used as the activator with an Al/M ratio of 1,000 (M=Zr, Hf). The catalysts were tested without isolation and purification. The catalysts were first screened under B2 conditions as set forth in Table 2. For the polyrnerizations performed at 50° C. and without hydrogen (Entries 1, 4, 5, and 6 of Table 2), the activity trend is as follows:
C2>>C6>C3>C4

When a small quantity of hydrogen (H₂/C₂ 0.005) was added to the polymerization reaction and the temperature increased to 80° C., a catalyst activity increase was observed for catalyst C2 (Entry 3, Table 2). An increase of catalyst activity is also observed for the co-polymerization of ethylene with 1-hexene (Entry 2, Table 2). Furthermore, decreasing the ethylene concentration (Entry 4, Table 2), did not affect the catalyst activity. The polymers obtained from the B2 homopolymerization conditions could not be tested for Mw in the GPC instrument due to the high viscosity of the solutions from the samples in trichlorobenzene. However, the polymer from the ethylene/1-hexene copolymerization (Entry 2, Table 2) showed an Mw of 1,493,330 from the GPC data. In addition, these polymers would not flow during the melt index test. None of the PE samples could provide rheological data due to the inability to form the plaques required for the test. Nevertheless, the DSC analysis did provide melting point data for the all of the samples and from the DSC data, the density and the percent crystallinity were calculated. In addition, C13-NMR analysis provided the microstructures of selected polymer samples (Entries 1, 2, 3 and 6 of Table 2). From the DSC and C13-NMR data, it is proposed that the polymers obtained from the homo-polymerizations consisted of very high Mw linear high density PE. Although polymers from the homopolymerization and copolymerization showed equal calculated densities, the polymer from the copolymerization of ethylene and 1-hexene showed evidence of a copolymer product from C13-NMR and DSC analysis with the C13-NMR indicating 0.2 wt. % C₆. In addition, a lower melting temperature was observed from the DSC results (second melt peak 133.0° C.) when compared to the polymer obtained from the homo-polymerization of ethylene (second melt peak 139.3° C.) as indicated by Entries 1 and 2 in Table 2.

TABLE 2
Ethylene Polymerizations Under B2 Conditions^{(a)}

| | | Cat | Ethylene | | 1-Hexene | Temp | | Activity | | |
|---|---|---|---|---|---|---|---|---|---|---|
| Entry # | Catalyst # | mg | wt. % | H2/C2 | (wt. %) | (° C.) | Yield | (gPE/gcat/h) | Mw | Melt Index |
| 1 | C2 | 5 | 7 | 0 | 0 | 50 | 63 | 25,200 | Too High for GPC | |
| 2 | C2 | 5 | 8 | 0 | 2.44 | 80 | 120 | 48,000 | 1,493,330 | No flow |

| | | | | | | | | | |
|---|---|---|---|---|---|---|---|---|---|
| 3 | C2 | 5 | 7 | 0.005 | 0 | 80 | 161 | 64,400 | Too High for GPC |
| 4 | C2 | 5 | 4 | 0 | 0 | 80 | 70 | 28,000 | |
| 5 | C3 | 5 | 7 | 0 | 0 | 50 | 16 | 6,400 | |
| 6 | C4 | 20 | 7 | 0 | 0 | 50 | 15 | 1,500 | |
| 7 | C6 | 10 | 7 | 0 | 0 | 50 | 50 | 10,000 | |

^{(a)}Polymerization conditions: Polymerization diluent, isobutane; reaction time, 30 min.; Al/Zr, 1,000 (MAO 30 wt. % in toluene, Albemarle)

TABLE 3
DSC Results from Ethylene Polymerizations Under B2 Conditions

| | | | | □H | Second | | | |
|---|---|---|---|---|---|---|---|---|
| | | | Recrystallization | Recrystallization | Melt Peak | □H Second | Calculated | % |
| Entry # | Monomer | Catalyst # | Peak (° C.) | (J/g) | (° C.) | Melt (J/g) | Density | Crystallinity |
| 1 | C₂ | C2 | 114.3 | −164.2 | 139.3 | 168.7 | 0.94 | 58.1 |
| 2 | C₂/1- | C2 | 119.9 | −159.3 | 133.0 | 160.4 | 0.94 | 55.3 |
| | hexene | | | | | | | |
| 3 | C₂ | C2 | 113.3 | −187.7 | 138.0 | 180.6 | 0.94 | 62.2 |
| 4 | C₂ | C3 | 118.6 | −228.7 | 136.7 | 178.5 | 0.94 | 61.6 |
| 5 | C₂ | C4 | 115.9 | −154.3 | 142.7 | 134.2 | 0.93 | 46.3 |
| 6 | C₂ | C6 | 115.9 | −213.3 | 133.4 | 192.5 | 0.95 | 66.4 |

Because of the high activity of catalyst C2 in the polymerization of ethylene under one atmosphere and under B2 conditions, further screening of catalyst C2 was conducted under B1 conditions as set forth in Table 4. Initial observations showed that, without the use of hydrogen, the catalyst activity doubled under B2 polymerization conditions (Entry 1, Table 4) when compared to B1 (Entry 1, Table 2). However, analysis of the PE for GPC, melt flow or rheology was not possible due to the very high Mw. The polymerizations of ethylene in the presence of hydrogen (Entries 1 and 2, Table 4) show that catalyst C2 has a good hydrogen response. An increase of the H₂/C₂ ratio from 0.125 to 0.250 shows a decrease in Mw and an increase in the melt flow (Entries 1 and 2, Table 4). In addition, rheology data as set forth in Table 5 shows an increase of both the relaxation time and the breadth parameter with the increase of hydrogen.

TABLE 4
Homopolymerizations of Ethylene with Catalyst C2 Under B1 Conditions^{(a)}

| | | Yield | Activity | | | | Mw/ | Peak | MI2 | MI5 | HLMI | |
|---|---|---|---|---|---|---|---|---|---|---|---|---|
| Entry # | H2/C2 | (g) | (gPE/gcat/h) | Mn | Mw | Mz | Mz | Mw | (g/10 min.) | (g/10 min.) | (g/10 min.) | SR5 |
| 1 | 0.000 | 132 | 52,800 | Too High for GPC | | | | | | | | |
| 2 | 0.125 | 95 | 38,000 | 9051 | 122059 | 1229625 | 13.5 | 51239 | 1.4 | 5.06 | 83.8 | 16.6 |
| 3 | 0.250 | 67 | 26,800 | 6429 | 57581 | 472493 | 9 | 4600 | 17.5 | 68.8 | >800 | 11.6 |

^{(a)}Polymerization conditions: Polymerization diluent, hexane (3.5 wt. % ethylene content); reaction temperature, 80° C.; reaction time, 30 min.; Al/Zr, 1,000 (MAO 30 wt. % in toluene, Albemarle)

TABLE 5
Rheology Data for PE obtained from Catalyst C2 under B1 Conditions

| | Entry 3 | Entry 2 |
|---|---|---|
| Frequency Temperature Sweep | Yes | Yes |
| Ea (kJ/mol) | 34.29 | 29.67 |
| η (Pa · s) | 4.57E+03 | 1.88E+04 |
| Relaxation Time (sec) | 0 | 0.015 |
| Breadth Parameter | 0.154 | 0.236 |
| Temperature (° C.) | 190 | 190 |
| n parameter | 0 | 0 |

Heterogenization for catalyst C2 was achieved by using a MAO/SiO2 silica support having an average particle size of 50-130 microns. Up to 4 wt. % of the catalyst was immobilized on the support without any indication of catalyst leaching. The catalyst was tested in the homo-polymerization of ethylene under B1 and B2 configurations in the Zipperclave reactors. Under both B1 and B2 configurations, the supported catalyst showed an activity decrease when compared to the non-supported catalysts. Under B1 conditions, the supported catalyst showed a much higher hydrogen response (Entries 1 and 2, Table 6). In addition, the GPC data showed that the Mw of the polymers produced under B1 conditions decreased by about half for the supported catalyst. Furthermore, both the supported and non-supported catalysts could not produce GPC data because of the high Mw polymer produced under the B2 configuration (Entries 3 and 4, Table 6).

TABLE 6
Comparison of Catalyst C2 Supported vs. Non-supported in Ethylene Polymerization
under B2 and B1 Conditions¹⁾

| | | | | | | | | Activity | | | | | | |
|---|---|---|---|---|---|---|---|---|---|---|---|---|---|---|
| | Polymerization | | Cat | Tibal | C2 | | Yield | (gPE/ | Bulk | | | | | Peak |
| Entry # | Type | Catalyst | mg | (mmol) | wt. % | H2/C2 | (g) | gcat/h) | Density | Mn | Mw | Mz | Mw/Mz | Mw |
| 1 | B1 | Non- | 5 | 0 | 3.5 | 0.25 | 67 | 26,800 | n.d. | 6,429 | 57,581 | 472,493 | 9 | 4600 |
| | | Supported | | | | | | | | | | | | |
| 2 | B1 | Supported³⁾ | 200 | 0.50 | 3.5 | 0.25 | 9 | 90 | n.d. | 3,356 | 25,484 | 200,191 | 7.6 | 1033 |

| | | | | | | | | | | |
|---|---|---|---|---|---|---|---|---|---|---|
| 3 | B2²⁾ | Non- | 5 | 0 | 7 | 0 | 63 | 25,200 | n.d. | Too High |
| | | Supported | | | | | | | | |
| 4 | B2 | Supported³⁾ | 100 | 0.63 | 8 | 0 | 31 | 620 | 0.28 | Too High |

¹⁾Polymerization conditions: Temperature, 80° C.; Time, 30 min.; Tibal (AKZO 25.2 wt. % in Heptane);
²⁾Temperature, 50° C.; n.d., not determined;
³⁾The catalyst support was prepared by mixing 0.50 g of MAO/SiO2 G-952 was slurried in 10 ml of toluene and then slowly added 22.36 mg (in 1.8 mLbenzene-d6) of catalyst C2 at 20° C., after stirring overnight, it was filtered, washed with hexane and dried by vacuum and slurried in mineral oil.

The particle size distribution and polymer morphology for the PE obtained from the supported catalyst C2 under B2 polymerization condition were analyzed. The particle size distribution curve shows a narrow particle size distribution with a D50 of 126. In addition, a microscopy comparison of the MAO/SiO₂ to the polymer fluff shows that the particle fluff is obtained in a uniform manner with a replica effect of the particle shape obtained from the support.

Zirconium-based catalysts C2, C3 and C4 were tested in bulk propylene polymerization at 60° C. As in the polymerizations of ethylene, these catalysts were tested without isolation and purification from the reaction mixture. Upon activation with MAO, these catalysts were active in the polymerization of propylene. The results are summarized in Table 7 below. Initial results showed that these catalysts produced clear sticky gels (soluble in hexane). The activity trend was shown to be C3>C2>C4.

TABLE 7

| | Catalyst | | Activator | Temp | Time | | Activity(gPE/ |
|---|---|---|---|---|---|---|---|
| Catalyst # | (mg) | Activator | (mmole) | (° C.) | (min.) | Yield | gcat/h) |
| C2 | 20 | MAO^{(a)} | 9.5 | 60 | 60 | 4.38 gel | 219 |
| C3 | 10 | MAO | 9.5 | 60 | 30 | 1.18 gel | 236 |
| C4 | 53 | MAO | 9.5 | 60 | 60 | 0.94 gel | 17 |

^{(a)}MAO (30 wt. % in toluene, Albemarle)

The Zr catalysts obtained from the (N,N,N) tridentate ligands with C₂ symmetry (catalysts C2 and C3) resulted in polypropylenes with moderate isotacticities characterized by 22.3% mmmm and 26.4% mmmm pentads, respectively. Catalyst C4 produced an amorphous polymer with low syndiotacticity characterized by 10.1% rrrr pentads. The pentad distributions observed for the polypropylenes produced with catalysts C2, C3 and C4 are set forth in the following table in which a meso dyad 15 indicated by “m” and a raceinic dyad by “r”.

TABLE 8

| | Catalyst | Catalyst | Catalyst |
|---|---|---|---|
| Pentad | C2 | C3 | C4 |
| mmmm | 22.3 | 26.4 | 8.9 |
| mmmr | 14.7 | 15.7 | 7.7 |
| rmmr | 3.9 | 3.4 | 4.4 |
| mmrr | 17.4 | 16.7 | 9.4 |
| xmrx | 13.8 | 11.9 | 21.9 |
| mrmr | 5.5 | 4.6 | 11.9 |
| rrrr | 5.8 | 4.8 | 10.1 |
| rrrm | 7.6 | 7.1 | 15.7 |
| mrrm | 9 | 9.4 | 9.9 |
| % meso | 59.2 | 62.2 | 42.7 |
| % racemic | 40.8 | 37.8 | 57.3 |

Having described specific embodiments of the present invention, it will be understood that modifications thereof may be suggested to those skilled in the art, and it is intended to cover all such modifications as fall within the scope of the appended claims.

1. A process for the preparation of a tridentate transition metal catalyst component comprising:
providing an organo transition metal compound characterized by the formula:
MRₙ (1)
wherein:
each R is independently a C₁-C₂₀ alkyl group, a C₆-C₃₀ aryl group, a C₇-C₃₀ alkyl aryl group, a C₁-C₂₀ alkoxy group, a C₇-C₃₀ aryloxy, or a C₁-C₂₀ amido-group.
n is from 3 to 5
M is a group 4 or group 5 transition metal
reacting said transition metal compound with an imino-pyridinyl ligand compound characterized by the formula: 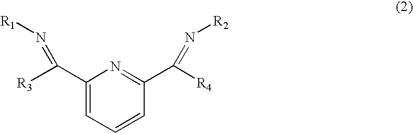
wherein:
R₁ and R₂, R₃, R₄ are each independently a C₁-C₃₀ aliphatic group; or a C₆-C₃₀ aryl group, C₁-C₂₀ alkoxy group, a C₇-C₃₀ aryloxy group, a C₁-C₂₀ amido-group, or a C₄-C₃₀ alicyclic group.
n is from 3 to 5
or by the formula: 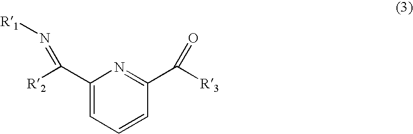
wherein:
R′₁, R′₂ or R′₃ are each independently a C₁-C₃₀ hydrocarbyl group to produce a catalyst component characterized by the formula: 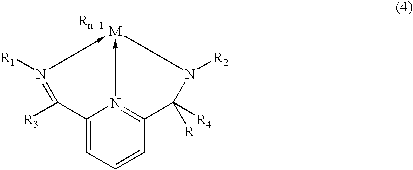
in which the tridentate ligand is bonded to the metal M by one sigma bond and two dative bonds
wherein:
M, R, R₁, R₂, R₃ and R₄ and n are as defined above
or by the formula: 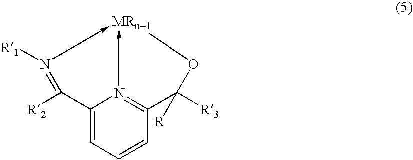
in which the tridentate ligand is bonded to the metal M by one sigma bond from oxygen and two dative bonds.
wherein:
M, R′₁, R′₂, R′₃, R and n are as defined above.

2. The process of claim 1 wherein R is a mononuclear aryl group.

3. The process of claim 1 wherein R is a C₁-C₄ alkyl group.

4. The process of claim 1 wherein R is a benzyl group.

5. The process of claim 1 wherein R₃ and R₄ and R′₂ and R′₃ are methyl groups

6. The process of claim 1 wherein R₂,R₃ and R′₁ are monoaromatic or polyaromatic groups.

7. The process of claim 5 wherein R is a benzyl group.

8. The process of claim 7 wherein M is selected from the group consisting of titanium, zirconium and hafnium.

9. A process for the preparation of a tridentate transition metal catalyst component comprising:
providing a phenyl transition metal compound characterized by the formula:
M(R_{f}Ph)₄ (6)
wherein:
Ph is a phenyl group;
M is a group 4 or group 5 transition metal
R_{f} is a functional substituent on the phenyl group linking the phenyl group to the transition metal M; and
reacting said transition metal compound with an imino-pyridinyl ligand compound characterized by the formula: 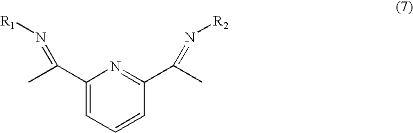
wherein:
R₁ and R₂ are each independently a C₁-C₁₄ hydrocarbyl group;
or by the formula 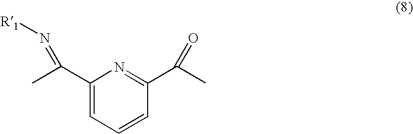
wherein:
R′₁ is a C₁-C₂₀ hydrocarbyl group
to produce a catalyst component characterized by the formula: 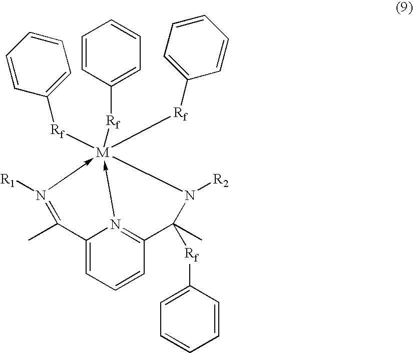
or by the formula:

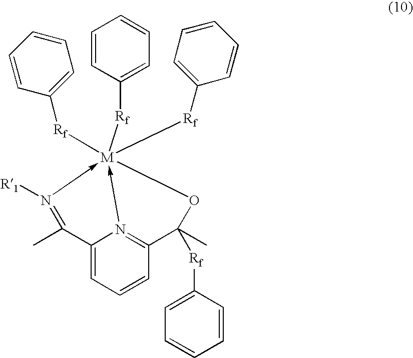

10. The process of claim 9 wherein R_{f} is an alkyl group, an aryl group, an imido group, an imino group, an ether group, an alkyl group, or an aryl group.

11. The process of claim 10 wherein R_{f} is a mononuclear aryl group.

12. The method of claim 10 wherein R_{f} is C₁-C₃ alkyl group.

13. The method of claim 12 wherein said alkyl group R_{f} is a methyl group and said catalyst component is characterized by the formula: 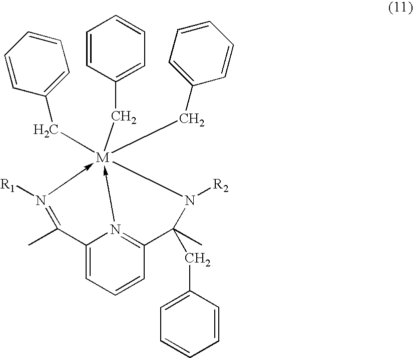
or by the formula:

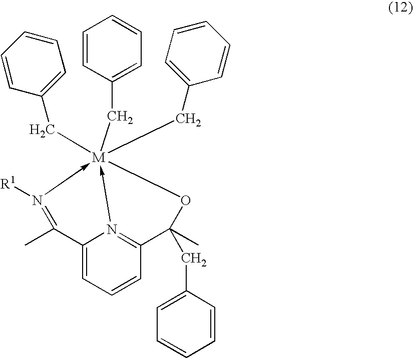

14. The process of claim 13 wherein said imino-pyridinyl ligand is characterized by the formula: 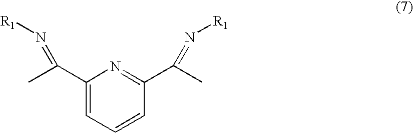
and said catalyst component is characterized by the formula:

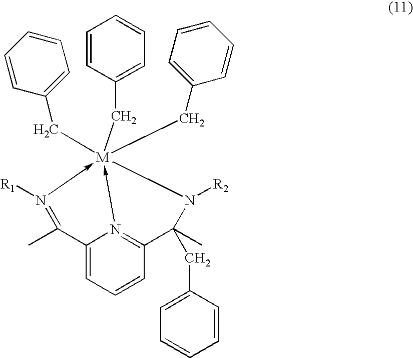

15. The process of claim 14 wherein R₁ and R₂ are each independently an aryl group that is substituted or unsubstituted.

16. The process of claim 15 wherein R₁ and R₂ are each independently a mono-nuclear aryl groups that is substituted or unsubstituted.

17. The process of claim 14 wherein said aryl groups R₁ and R₂ are the same and are polynuclear aryl groups.

18. The process of claim 17 wherein R₁ and R₂ are indenyl groups which are substituted or unsubstituted.

19. The method of claim 15 wherein R₁ and R₂ are each fluorenyl groups which are the same or different and are substituted or unsubstituted.

20. The method of claim 14 wherein M is a group 4 transition metal.

21. The method of claim 20 wherein M is zirconium or hafnium.

22. The method of claim 13 wherein said transition metal compound is a tetrabenzyl compound characterized by the formula M(CH₂Ph)₄ and said imino-pyridinyl ligand is characterized by the formula: 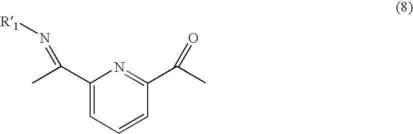
and said catalyst component is characterized by the formula:

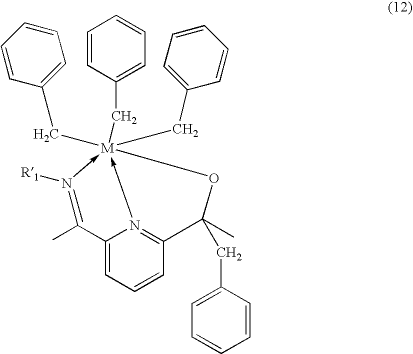

23. The process of claim 22 wherein R′₁ is an aryl group that is substituted or unsubstituted.

24. The process of claim 22 wherein R′₁ is a mono-nuclear aryl group that is substituted or unsubstituted.

25. The process of claim 23 wherein R′₁ is a polynuclear aryl group.

26. The process of claim 25 wherein R′₁ is an indenyl group which is substituted or unsubstituted.

27. The method of claim 25 wherein R′₁ is a fluorenyl group which is substituted or unsubstituted.

28. The method of claim 22 wherein M is a group 4 transition metal.

29. The method of claim 28 wherein M is zirconium or hafnium.
